(19) United States
(12) Patent Application Publication
(10) Pub. No.: US 2010/0218574 A1
(43) Pub. Date: Sep. 2, 2010

(54) METHOD FOR TREATING BIO-ORGANIC AND WASTEWATER SLUDGES

(75) Inventors: Grant H. Mills, Mississauga (CA); Robert Sampson, Toronto (CA); Rae E. Wallin, Maitland (CA)

Correspondence Address: Manelii Denison & Selter PLLC, 2000 M Street, 7th Floor, Washington DC, DC, 20036, US

(73) Assignee: N-VIRO SYSTEMS CANADA LP, Toronto (CA)

(21) Appl. No.: 12/706,025

(22) Filed: Feb. 16, 2010

(30) Foreign Application Priority Data
Feb. 27, 2009 (CA) 2,656,390

(51) Int. Cl. C05F 7/00; B01J 19/18; C02F 11/00

(52) U.S. Cl. 71/12; 422/224; 422/225

(57) ABSTRACT

An improved process of treating sludge to provide a stable product for use as a beneficial soil or fertilizer for agricultural lands which includes the steps (a) mixing the sludge with at least a first alkaline material and a second alkaline material in an amount sufficient to (i) raise the solids content of the mixed material to at least 50% W/W; (ii) raise the pH to at least 12; and (iii) raise the temperature to at least 70° C. by exothermic reaction of the alkaline materials with the water in the sludge; and (b) pasteurizing the mixed material at (i) at least 70° C. for at least 30 mins. and at least pH12 for at least 2 hrs.; and (ii) at least pH 11.5 for an additional 22 hrs., to provide the stable pasteurized product. The process and apparatus is readily adapted for mobility on suitable transportation.

### FIELD OF THE INVENTION

This invention relates to a method of treating bio-organic and/or wastewater sludges that is designed to microbially decontaminate and stabilize the sludge so that it can be safely utilized as a soil amendment or fertilizer in agriculture or as a component of synthetic soil for general usage.

### BACKGROUND OF THE INVENTION

Relevant prior art references for providing a full understanding of the use of bio-organic and wastewater sludges as beneficial soil or fertilizers for agricultural lands and processes for the production of treated sludges include U.S. Pat. Nos. 4,781,842; 4,902,431; 5,275,733; 5,417,861; 5,853,450; 5,853,590; 6,248,148 and 6,407,038; and references contained therein.

Of particular mention is U.S. Pat. No. 5,853,590 which describes a method of treating sludge to provide a stable product for use as a beneficial soil or fertilize for agricultural lands, which includes the steps of (a) mixing sludge with at least one alkaline material in an amount sufficient to raise the pH of the mixture to a level of at least 12 and to increase the percent of solids in the mixture to at least 40% by weight, and such that the odorant sludge organics and inorganics are bound to adsorbent particles of the alkaline material, (b) aerating and drying the mixture by agitation and heating to stabilize the mixture and increase the percent solids to at least 50% by weight, and (c) pasteurizing the dried mixture at a temperature at or above 52.degree. C. by application of heat resulting from an exothermic reaction of the alkaline material with water in the sludge, wherein said step (b) is carried out in a mechanical means selected from the group from the group consisting of a drum dryer, a pelletizer, and a fluidized bed apparatus, and wherein the heat applied for drying in said step (b) reduces the amount of additional heat required for pasteurization in said step (c) thereby reducing the amount of alkaline material needed for said exothermic reaction.

Canadian Patent No. 2,410,814, issued 22 Jan. 2008 and assigned to N-Viro Systems Canada, Inc., Ontario, describes an improved process over aforesaid U.S. Pat. No. 5,853,590 wherein sufficient time is allowed under step (a) prior to step (b) to enable sufficient slaking of the alkaline material in the mixture to prevent or limit the removal of the mixture as dust during step (b). This is achieved by providing for further time for reaction of the water in the sludge with the alkaline material prior to the aeration and drying step. This extra time over that disclosed in the prior art may be in the mixer alone or in conjunction therewith, for example as in a static mixer per se, a feed hopper or conveyor belt apparatus by which the alkaline mixture is fed to the aerator/dryer, either in a batch or, most preferably, continuous manner.

Wastewater sludge is a sludge comprised of the solids portion of the inflow of a wastewater treatment plant that normally is comprised of microorganisms, organics and inorganic precipitates that are separated from the water effluent discharge from the plant. This sludge is often unprocessed beyond a concentration process and is termed a raw sludge. Other sludges from a wastewater plant have been processed and are considered digested sludges or secondary or waste-activated sludges or combined sludges.

Bioorganic sludge is an organic sludge comprised of a material or materials selected from the group: sludges resulting from production of antimicrobials and other pharmaceutical products, bacterial fermentation sludges, sludges resulting from production of beer and wine, mushroom compost waste, paper mill sludges, sludges that contain microorganisms that have resulted from recycled organic products such as paper products, sludges resulting from the growth of microorganisms for the production of chemicals and organics, industrial sludges and byproducts resulting from the production of microbial products and foodstuffs, sludges resulting from the animal slaughter industry—particularly if these are digested or otherwise broken down by microorganisms.

Organic sludge is a sludge derived from industrial products and byproducts that are comprised in the majority microbially degradable organic materials not of biological or microbiological origin. This definition would include sludges comprised of recycled organic products such as recycled paper and paper products.

Preliminary or pretreatment is the very first stage of sludge treatment, involving, the removal of larger materials and grit that if not removed could hinder subsequent treatment processes. It is accomplished through the use of equipment such as bar screens, macerators, comminutors, racks and grit removal systems.

Primary treatment is usually comprised of preliminary treatment followed by primary clarifiers which remove approximately 50% suspended solids and 35-40% B.O.D.5. This is accomplished by channeling flows through large tanks with residence times of 2-4 hours, thus allowing suspended solids to settle. Post disinfection and a biosolids treatment process are normally included. Enhanced Primary Treatment can be performed by the addition of a coagulant such as ferric chloride along with a polymer, improving the degree of S.S. and B.O.D. removal to 80% and 60% respectively.

Secondary treatment involves a primary process and a biological treatment stage. There are many biological processes in the treatment operation with the majority being variations of fixed film and mixed culture applications. The activated sludge process (mixed) is achieved by establishing large diversified cultures of bacteria. The bacteria metabolizes and provides the enzymatic breakdown of organic components, i.e., liquids, carbohydrates, proteins and cellulose, in the wastewater. 90% removal rates of B.O.D. and suspended solids are typical of secondary treatment.

However, although the manufacturing process described in aforesaid U.S. Pat. No. 5,853,590 provides an improvement in the art, it suffers from a drawback of allowing dust particles of the alkaline treated sludge to be carried off during the air-drying step of the process and create an unsafe environment and or the necessity to dispose of such dust.

However, although the manufacturing process described in Canadian Patent No. 2,410,814 provides an improvement in the art, it employs a mechanical dryer and associated equipment, including emissions control equipment. Reference to the dryer, hereinafter, is deemed to include the emissions' control equipment which can carry a high capital cost, consume a significant amount of electricity and fuel, making it uneconomical in some situations, and make the portability of the process difficult or even impossible.

There is therefore a need for an improved process of treating sludge to provide a stable product that does not suffer from the aforesaid disadvantages.

### SUMMARY OF THE INVENTION

It is an object of the present invention to provide a process of treating sludge that eliminates at least the mechanical drying step to provide a stable beneficial product that can be produce using a mobile production facility or a permanent production facility.

The term Class A is meant in the art that the product qualifies as a pathogen reduction method, alternatives #1 and #5, use of PFRP in Part 503. The product also meets the vector attraction rule specified in 40 CFR 503. Further, the product is qualified as EQS by meeting Table 3 pollutant limits.

Surprisingly, we have discovered that the drying step can be eliminated by applying relatively high dosages of suitable alkaline materials in appropriate ratios while achieving the desired chemical and physical product qualities and, as an added benefit, increase the product value for agricultural uses and also making the process capable of being moved from location to location.

Accordingly, in one aspect, the invention provides an improved process of treating sludge to provide a stable product for use as a beneficial soil or fertilizer for agricultural lands which includes the steps of

(a) mixing the sludge with at least a first alkaline material and a second alkaline material in an amount sufficient to (i) raise the solids content of the mixed material to at least 50% W/W; (ii) raise the pH to at least 12; and (iii) raise the temperature to at least 70° C. by exothermic reaction of the alkaline materials with the water in the sludge to produce a resultant material; and

(b) pasteurizing said resultant material at a temperature of at least 70° C. and a pH of at least 11 for a sufficient time to effect complete pasteurization to a standard Class A as aforesaid defined.

Preferably, step (b) comprises pasteurizing said mixed material at (i) at least 70° C. for at least 30 mins and at least pH12 for at least 2 hrs.; and (ii) at least pH 11.5 for an additional 22 hrs., to provide said stable product.

Essential goals to be achieved through the addition of alkaline materials to sludges are to raise the temperature and pH levels such that pathogens are destroyed, to raise the solids levels of the product to allow for ease of application to agricultural lands and to enhance the value of the product to agriculture through the provision of crop nutrients which are inherent in the alkaline materials.

Surprisingly, we have found that the addition to sludges of a low-reactivity material, e.g. cement-kiln dust, lime-kiln dust and/or flyash, or other similar materials whose main purpose is to bulk up the solids of the mixture, along with a high-reactivity material, e.g. quicklime or slaked lime, whose main purpose is to raise the temperature and pH of the mixture in certain combinations meets the goals described above.

We have found that by increasing the alkaline admixture dosages significantly over those according to prior art, the pathogen destruction, solids levels and product enhancement value goals can be achieved with a reduction in capital and operating costs.

By judicial selection of the amount of the high-reactivity material in conjunction with a suitable amount of the low-reactivity material, the desired goals of the present invention are achieved.

Of particular benefit in the practice of the invention is the achievement of the at least 70° C. temperature by addition of suitable relative amounts of the high-reactivity material for efficacious pasteurization.

Preferably, the first alkaline material is a low-reactivity material, such as, for example, an alkaline material selected from the group consisting of cement-kiln dust, lime-kiln dust and flyash and other like material.

Further, the second alkaline material is a high-reactivity material, such as, for example, quicklime (calcium oxide) and slaked lime (calcium hydroxide) and other like material.

The term “low reactivity” means low efficacy with respect to temperature and pH increases in both time and value while “high reactivity” means high efficacy with respect to temperature and pH increases in both time and value.

Preferably, the ratio of the first alkaline material to the second alkaline material is selected from the range 2:1 to 8:1 by wet weight, more preferably from 3:1 to 5:1.

Dosages of the added alkaline materials will vary depending on the sludge percent solids. The lower the solids the higher the alkaline material dosage and whereas the higher the percent solids, the lower the dosage. Typical combined alkaline material dosages are 60% by wet weight when the sludge solids content is 20%, and 40% when the sludge solids are 30% to achieve a mixed solids concentration of 50% and the aforesaid targeted temperature and pH levels.

As the temperature of the mixture increases from 52° C. as taught by the prior art to over 70° C. by judicial addition of the high-reactivity material, according to the invention, ammonia gas is released at a rate several fold over the prior art processes.

The amount of the low-reactivity material, e.g. cement-kiln dust required in the process of the invention is advantageously increased over the amount of use in prior art applications. This provides an environmentally improved advantage of manufacturing by-product that would alternatively require disposal at a landfill.

The process according to the invention comprises the steps and apparatus shown in Canadian Patent No. 2,410,814 modified to eliminate the conveyor unit and mechanical drying step and to, optionally, include ammonium sulphate production and product shredding or conditioning.

The sludge is preferably selected from a group consisting of raw primary wastewater sludge, enhanced primary treated sludge, digested wastewater sludge, secondary wastewater sludge, secondary wastewater sludge, combined wastewater sludge, a product of industrial process that includes microbial cells or components, bioorganic sludges, organic sludges and mixtures thereof.

In a further aspect, the invention provides apparatus for treating sludge to provide a stable product for use as a beneficial soil or fertilizer for agricultural lands comprising

mixing means for mixing the sludge with at least a first alkaline material and a second alkaline material in an amount sufficient to (i) raise the solids content of the mixed material to at least 50% W/W; (ii) raise the pH to at least 12; and (iii) raise the temperature to at least 70° C. by exothermic reaction of the alkaline materials with the water in the sludge to provide a resultant mixture; and

pasteurizing means for pasteurizing said resultant mixture at a temperature of at least 70° C. and a pH of at least 11 to obtain said stable product.

Preferably, the mixing means comprises (i) a first alkaline material first storage and feeding means; (ii) a second alkaline material second storage and feeding means; and (iii) intimate mixing means for intimately mixing said first alkaline material fed from said first storage and feeding means with said second alkaline material fed from said second storage and feeding means to provide a resultant admixture.

Further, preferably, each of the first and second alkaline material storage and feeding means comprises a silo.

Yet further, the intimate mixing means comprises a conveyer mixer.

The invention is of particular value in the practise of the invention wherein the supply of sludge is not of a scale to justify the capital expenditure or full-time operation costs of a permanent establishment at any one or a plurality of sludge-producing locations. Surprisingly, we have discovered the invention lends itself to the transportation and temporary positioning of apparatus of use in the invention.

Accordingly, in a further aspect, the invention provides portable apparatus for providing the resultant admixture comprising transportation means associated with the mixing means.

In a further aspect, the invention as hereinabove defined provides portable apparatus further comprising the pasteurization means.

Preferably, the transportation means comprises a motorized vehicle, trailer or a railcar.

The pasteurization means preferably comprises a pasteurization container.

The portable apparatus comprises preferably dispensing means for dispensing the resultant admixture from or on the transportation means to the pasteurization means.

### BRIEF DESCRIPTION OF THE DRAWINGS

In order that the invention may be better understood, a preferred embodiment will now be described by way of example only, with reference to the accompanying drawings, wherein:

FIG. 1 is a diagrammatic representation of a process and apparatus in accordance with the prior art, according to aforesaid U.S. Pat. No. 5,853,590;

FIG. 2 is a diagrammatic representation of a process and apparatus in accordance with the prior art, according to aforesaid CA 2,410,814;

FIG. 3 is a diagrammatic representation of a process and apparatus, according to the invention;

FIG. 4 is a diagrammatic representation of a process and apparatus associated with transportation, according to the invention; and

wherein the same numerals denote like parts.

### DETAILED DESCRIPTION OF PREFERRED EMBODIMENTS

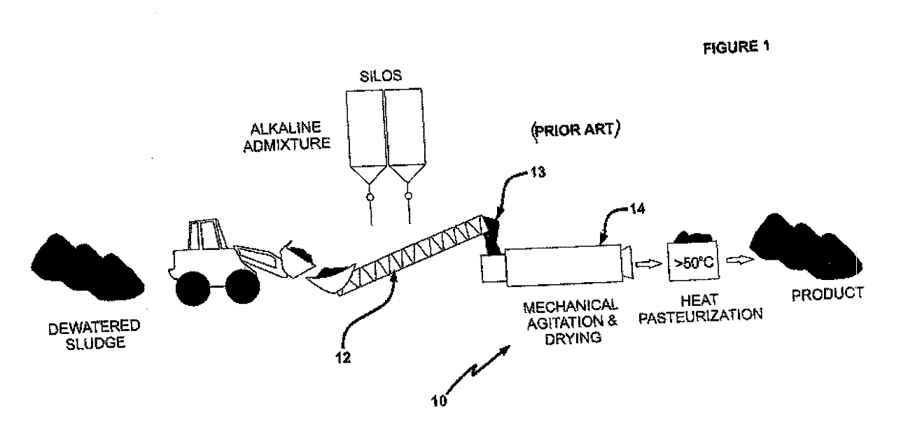

FIG. 1 shows prior art apparatus and process according to U.S. Pat. No. 5,853,590 generally as 10 wherein specifically dewatered sludge and alkaline admixtures are mixed in mixer 12 for an indeterminate period of time, typically, 0.5 to 1.0 minute at a throughput rate of, generally 10-50 tons/hr, preferably, 15 tons/hr, and the resultant mixture 13 fed to dryer 14. This process is known to produce dust particles in dryer 14 that get emitted as part of the dryer exhaust.

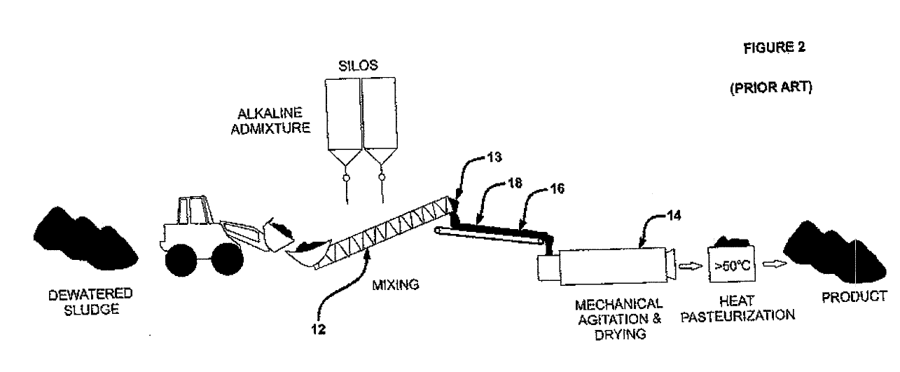

FIG. 2 shows a modified continuous operation and process of FIG. 1, wherein conveyor system 16 is used to transport alkaline enhanced primary treated sludge 18 to dryer 14 at a slow enough rate sufficient to allow full efficacious slaking, while at a fast enough rate to meet the demands of dryer 14 and satisfy the desired economics of the continuous process. Typical times are at least 3 minutes, preferably 15 minutes and more preferably 30 minutes. The resultant operative rate of mixture feed to dryer 14 can be met by judicious election of conveyor dimensions and speed, for the same throughput rates according to the prior art.

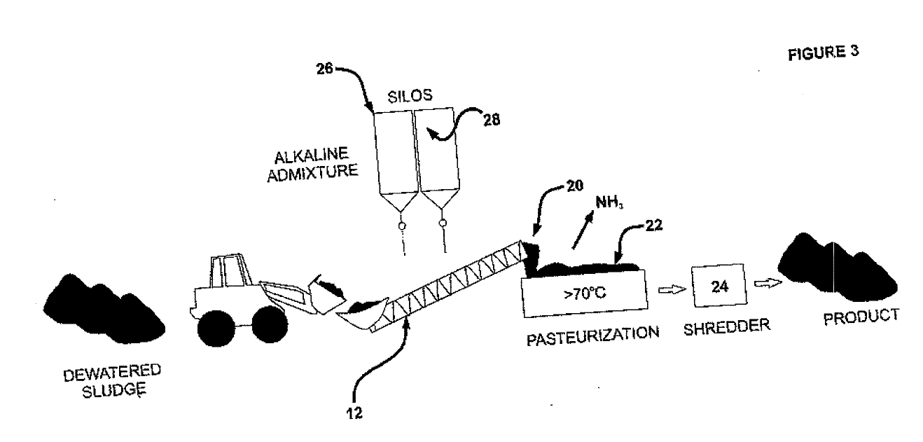

With reference to FIG. 3, this shows the mixing of the sludge/alkaline admixture of use according to the practise of the process of the invention in mixer 12 and transportation of resultant mixture 20 having a solids content of at least 50% W/W into pasteurization unit 22 operative at a temperature of at least 70° C. for at least 30 mins. at a pH of at least 12, followed by further pasteurization at pH 12 for at least 2 hrs. and for an additional 22 hrs. at a pH of at least 11.5. A first low-reactivity alkaline material comprising flyash in the embodiment shown is dispensed from silo 26; while high-reactivity second alkaline material is quicklime 28.

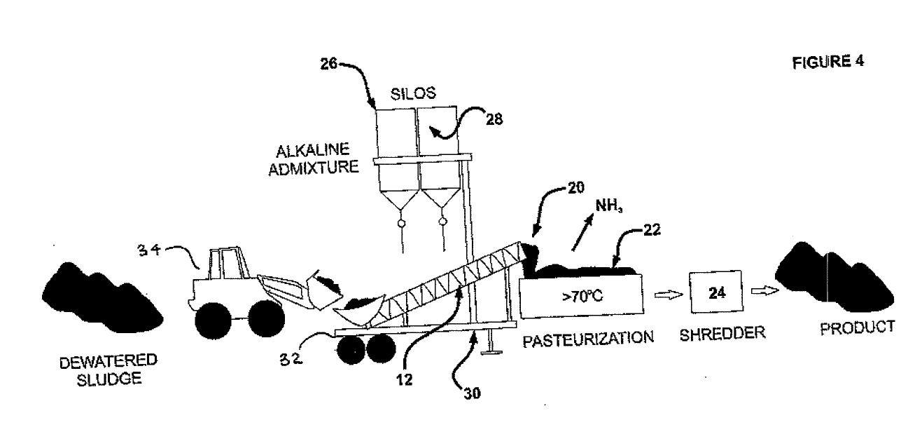

FIG. 4 shows conveyor mixer 12 and alkaline dispensing silos 26 and 28 suitably supported on bed 30 of a trailer 32. Resultant admixture 20 is fed from conveyer mixer 12 into pasteurizer 22. Sludge for treatment is dropped onto conveyer 12 by any suitable means, preferably a front-end loader 34.

In alternative embodiments, bed 30 may be a flatbed of a railcar. If desired, pasteurizers may be also located on bed 30.

The pasteurization step in unit 22 is sufficient to provide a stream of ammonia gas for subsequent absorption in sulfuric acid to provide ammonium sulfate fertilizer.

The cured, pasteurized product emanating from pasteurization unit 22 may be shredded or conditioned by shredder 24 to reduce particle size and provide particle uniformity.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. An improved process of treating sludge to provide a stable product for use as a beneficial soil or fertilizer for agricultural lands which includes the steps of
(a) mixing the sludge with at least a first alkaline material and a second alkaline material in an amount sufficient to (i) raise the solids content of the mixed material to at least 50% W/W; (ii) raise the pH to at least 12; and (iii) raise the temperature to at least 70° C. by exothermic reaction of the alkaline materials with the water in the sludge to produce a resultant mixture; and
(b) pasteurizing said resultant mixture at a temperature of at least 70° C. and a pH of at least 11 to obtain said stable product.

2. A process as claimed in claim 1 wherein step (b) comprises pasteurizing said mixed material at (i) at least 70° C. for at least 30 mins (ii) at least pH12 for at least 2 hrs.; and (iii) at least pH 11.5 for an additional 22 hrs., to provide said stable product.

3. A process as claimed in claim 1 wherein said first alkaline material is a low-reactivity material.

4. A process as claimed in claim 1 wherein said first alkaline material is selected from the group consisting of cement-kiln dust, lime-kiln dust and flyash or other simolat material.

5. A process as claimed in claim 1 wherein said second alkaline material is a high-reactivity material.

6. A process as claimed in claim 5 wherein said second alkaline material is selected from the group consisting of quicklime and slaked lime.

7. A process as claimed in claim 1 wherein the ratio of the first alkaline material to the second alkaline material is selected from the range 2:1 to 8:1 by wet weight.

8. A process as claimed in claim 7 wherein said ratio is selected from 3:1 to 5:1.

9. A process as claimed in claim 1 wherein the sludge is selected from the group consisting of raw primary wastewater sludge, enhanced primary treated sludge, digested wastewater sludge, secondary wastewater sludge, combined wastewater sludge, a product of industrial process that includes microbial cells or components, bioorganic sludges, organic sludges and mixtures thereof.

10. A process as claimed in claim 1 comprising removing ammonia released during said pasteurizing step (b).

11. A process as claimed in claim 1 comprising shredding or further conditioning said pasteurized product.

12. Apparatus for treating sludge to provide a stable product for use as a beneficial soil or fertilizer for agricultural lands comprising
mixing means for mixing the sludge with at least a first alkaline material and a second alkaline material in an amount sufficient to (i) raise the solids content of the mixed material to at least 50% W/W; (ii) raise the pH to at least 12; and (iii) raise the temperature to at least 70° C. by exothermic reaction of the alkaline materials with the water in the sludge to provide a resultant mixture; and
pasteurizing means for pasteurizing said resultant mixture at a temperature of at least 70° C. and a pH of at least 11 to obtain said stable product.

13. Apparatus as claimed in claim 12 wherein said mixing means comprises (i) a first alkaline material first storage and feeding means; (ii) a second alkaline material second storage and feeding means; and (iii) intimate mixing means for intimately mixing said first alkaline material fed from said first storage and feeding means with said second alkaline material fed from said second storage and feeding means to provide a resultant admixture.

14. Apparatus as claimed in claim 12 wherein each of said first and said second alkaline material storage and feeding means comprises a silo.

15. Apparatus as claimed in claim 13 wherein said intimate mixing means comprises a conveyer mixer.

16. Portable apparatus for providing said resultant admixture as defined in claim 12 comprising transportation means associated with said mixing means.

17. Portable apparatus as claimed in claim 16 further comprising said pasteurization means.

18. Portable apparatus as claimed in claim 16 wherein said transportation means comprises a motorized vehicle, trailer or a railcar.

19. Portable apparatus as claimed in claim 17 wherein said pasteurization means comprises a pasteurization container.

20. Portable apparatus as claimed in claim 16 comprising dispensing means for dispensing said resultant admixture from or on said transportation means to said pasteurization means.
